(19) United States
(12) Patent Application Publication
(10) Pub. No.: US 2004/0079817 A1
(43) Pub. Date: Apr. 29, 2004

(54) Spray-drawing apparatus

(76) Inventor: Huang-Chen Chang, Taipei (TW)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/688,395

(22) Filed: Oct. 16, 2003

(30) Foreign Application Priority Data
Oct. 23, 2002 (TW) 091216927

(51) Int. Cl. B05B 9/00

(52) U.S. Cl. 239/326

(57) ABSTRACT

A spray-drawing apparatus includes a tubular body and a cover. The tubular body is integrally formed with a liquid-storage chamber for storing liquid and an air supply chamber for acting as a passageway, wherein an air vent is formed on the tubular body. A writing element communicates with the liquid-storage chamber and absorbs the liquid, such that a user can write with the writing element. The cover is detachably coupled to the tubular body and is formed with an opening and a seal portion. By this arrangement, the liquid stored in the liquid-storage chamber can be sprayed from the opening by means of airflow from a user. And the writing element can be sealed by the seal portion when the apparatus is not in use.

### FIELD OF THE INVENTION

The present invention relates to spray-drawing apparatuses, and more particularly, to a spray-drawing apparatus for spraying particles of a liquid pigment.

### BACKGROUND OF THE INVENTION

A spray-drawing apparatus is a coloring tool for spraying liquid such as colorant, ink, paint, pigment or the like in the form of pulverized or nebulized particles. Many types of the spray-drawing apparatuses are available on the market, among which a tubular type of spray-drawing apparatus is suitable for both adults and children to use. This tubular spray-drawing apparatus is disclosed in U.S. Pat. No. 6,024,300, comprising: a hollow tubular casing 1, a tubular liquid source 2 and a mouthpiece 3, as shown in FIGS. 1A and 1B.

The tubular liquid source 2 stores colored ink (not shown) and has a pen nib 21, and can act as a color pen. To assemble the tubular spray-drawing apparatus, it is to align the tubular liquid source 2 with fins 11 formed in the tubular casing 1 and align the pen nib 21 with an opening 13 of the tubular casing 1; then insert the tubular liquid source 2 to the fins 11 of the tubular casing 1 until the pen nib 21 is coupled to the opening 13; and finally allow a long tube section 31 of the mouthpiece 3 to encompass the tubular casing 1.

Since an outer surface of the tubular liquid source 2 is spaced from an inner wall of the tubular casing 1 by means of the fins 11, thereby making the space in-between form an air passageway. When a user sends airflow through a nozzle 33 of the mouthpiece 3 into the spray-drawing apparatus, the airflow can spray the colored ink stored in the tubular liquid source 2 out of the apparatus for spray painting.

When the apparatus is not in use, the user may separate the tubular casing 1, the tubular liquid source 2 and the mouthpiece 3 apart; then allow the long tube section 31 of the mouthpiece 3 to enclose the tubular liquid source 2 in a manner that as to insert the pen nib 21 of the tubular liquid source 2 to a positioned section 35 of the mouthpiece 3; and finally couple the fins 11 of the tubular casing 1 to the tubular liquid source 2, as shown FIG. 1B, such that the pen nib 21 of the tubular liquid source 2 is sealed by the mouthpiece 3 and prevented from damage or drying.

However, for using or changing the operation mode of the above conventional spray-drawing apparatus, all structural parts including the tubular casing 1, the tubular liquid source 2 and the mouthpiece 3, are required to be disassembled or assembled. During the assembly operation, it needs to align the tubular liquid source 2 with the opening 13 of the tubular casing 1 or the long tube section 31 of the mouthpiece 3. Besides, the tubular casing 1 and the mouthpiece 3 need to have certain lengths to enclose the tubular liquid source 2 and fix themselves in position to each other, thereby making the assembly of the apparatus not easy to perform especially for children. If the apparatus is not properly assembled, it may not be operated or may even lead to damage to the apparatus. For example, when the apparatus intends to be changed to a non-operational mode, the apparatus firstly needs to be disassemble to separate all structural parts apart and then repeat the assembly operation with the tubular liquid source 2 aligned to the long tube section 31 of the mouthpiece 3 to insert the pen nib 21 to the positioned section 35 of the mouthpiece 3 so as to seal the pen nib 21 with the mouthpiece 3. This thereby brings about the difficulty and inconvenience to use and operate the above conventional apparatus.

Moreover, the tubular liquid source 2 has similar length to the tubular casing 1 and the mouthpiece 3, and is relatively short as compared to a normal pen. When the tubular liquid source 2 is used as a color pen, the relatively short tubular liquid source 2, the hollow tubular casing 1, and the long mouthpiece 3 is not comfortably held properly, thereby resulting in disadvantageous drawing and control.

Therefore, in light of the above drawbacks caused by the conventional apparatus, the problem to be solved herein is to provide a spray-drawing apparatus to overcome those drawbacks.

### SUMMARY OF THE INVENTION

In accordance with the foregoing drawbacks of the prior-art apparatus, an objective of the present invention is to provide a spray-drawing apparatus with a cover easy to be coupled thereto. Another objective of the invention is to provide a spray-drawing apparatus having an integrally formed body and thus easy to be assembled.

A further objective of the invention is to provide a spray-drawing apparatus easy to be held and operated.

In order to achieve the above and other objectives, the present invention provides a spray-drawing apparatus, in a preferred embodiment, comprising a tubular body, a first cover, and a second cover. The tubular body is integrally formed with a liquid-storage chamber for storing liquid, and an air supply chamber surrounding the liquid-storage chamber for acting as an air passageway within the tubular body. A writing element is provided at a front end of the tubular body and communicates with the liquid-storage chamber, such that the writing element can absorb the liquid to allow a user to write and paint with the writing element directly.

Each of the first cover and the second cover can be coupled to either the front end or a rear end of the tubular body in different operational modes. The first cover is formed with an opening communicating with the ambient, and a coupling portion for coupling the first cover to the tubular body. The second cover is formed with a seal portion and an air vent. When the first cover is coupled to the front end of the tubular body and the second cover is coupled to the rear end of the tubular body, the writing element is adapted to be in communication with the opening of the first cover, and the air vent is adapted to be in communication with the air supply chamber. As a result, the user can send airflow through the air vent to spray particles of the liquid stored in the liquid-storage chamber from the opening.

A lid may be detachably coupled to the liquid-storage chamber for use to refill or change the liquid and keep the liquid in the liquid-storage chamber airtight.

In another preferred embodiment, the spray-drawing apparatus according to the invention comprises a tubular body and a cover, wherein the tubular body is integrally formed with a liquid-storage chamber for storing liquid, an air supply chamber surrounding the liquid-storage chamber for acting as an air passageway, and an air vent formed at a rear end of the tubular body. A writing element is provided at a front end of the tubular body and communicates with the liquid-storage chamber, such that the writing element can absorb the liquid to allow a user to write and paint with the writing element directly. The cover is detachably coupled to the tubular body and is formed with an opening and a seal portion. The opening is in communication with the ambient, so as to allow a user to send airflow through the air vent to spray particles of the liquid from the opening at the time the cover is coupled to the tubular body. The seal portion is detachably coupled to the cover for sealing the writing element and preventing leaking of the liquid.

The spray-drawing apparatus according to the invention is provided with the integrally formed tubular body; in operation, the cover(s) can be coupled to or removed from the tubular body to perform different functions, such as writing, drawing and spray-painting, of the spray-drawing apparatus, and this operation is easily achieved even by a child, such that the spray-drawing apparatus according to the invention is simple in structure, assembly and operation and cost-effective to manufacture. Moreover, the length of the tubular body is similar to the average length of a pen, which is thus easy to be held and controlled by human hand.

### BRIEF DESCRIPTION OF THE DRAWINGS

The present invention can be more fully understood by reading the following detailed description of the preferred embodiments, with reference made to the accompanying drawings, wherein:

FIGS. 1A and 1B (PRIOR ART) are respectively an exploded view showing structural parts of an unassembled conventional apparatus and a cross-sectional view of the assembled conventional apparatus;

FIG. 2 is an exploded view showing a spray-drawing apparatus according to a first preferred embodiment of the present invention;

FIG. 3 shows a cross-sectional view of a first cover of the spray-drawing apparatus according to the first preferred embodiment of the invention;

FIG. 4 shows a cross-sectional view of a second cover of the spray-drawing apparatus according to the first preferred embodiment of the invention;

FIGS. 5A, 5B and FIG. 5C are cross-sectional views of the assembled spray-drawing apparatus according to the first preferred embodiment of the invention in different operational modes;

FIG. 6 is an exploded view showing a spray-drawing apparatus according to a second preferred embodiment of the invention;

FIG. 7 shows a cross-sectional view of a cover of the spray-drawing apparatus according to the second preferred embodiment of the invention; and

FIG. 8 shows a cross-sectional view of the assembled spray-drawing apparatus according to the preferred second embodiment of the invention.

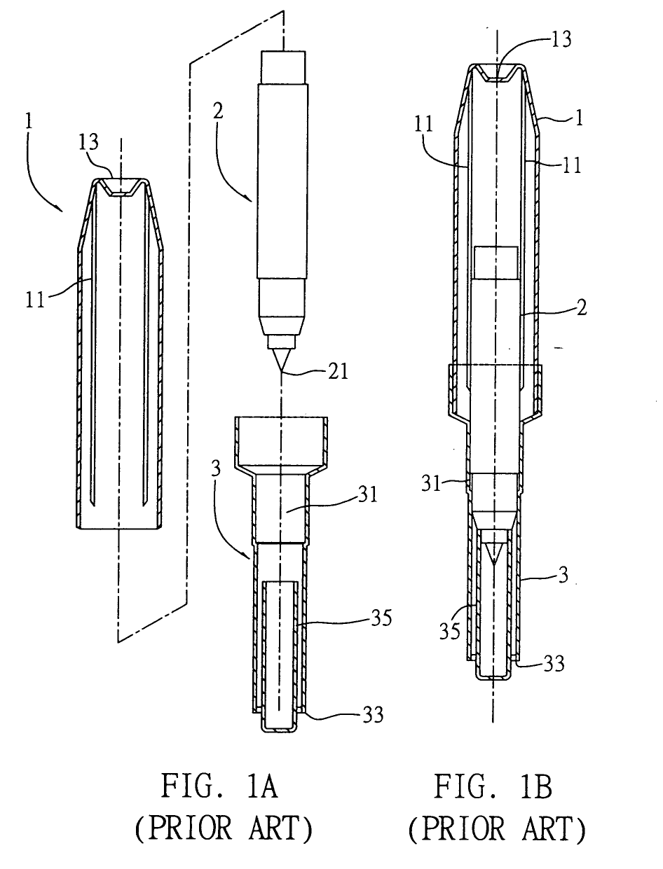

### DETAILED DESCRIPTION OF THE PREFERRED EMBODIMENTS

First Preferred Embodiment

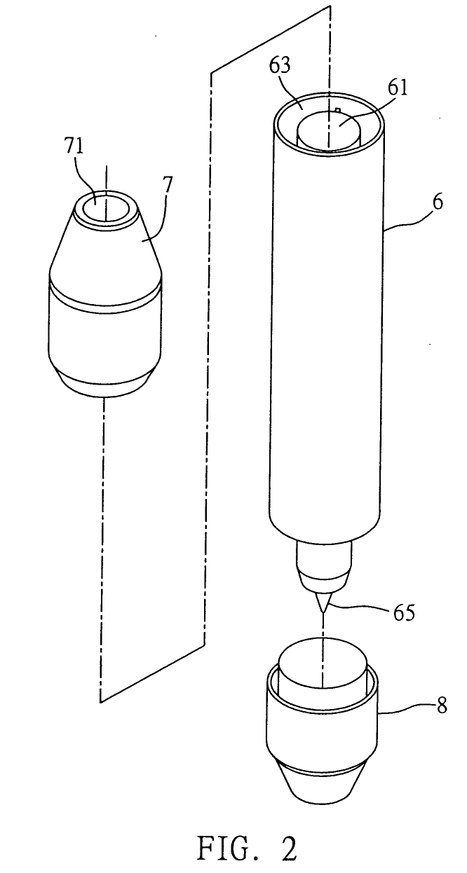

FIGS. 2 through 5C show a spray-drawing apparatus according to a first preferred embodiment of the present invention. As shown in FIG. 2. this spray-drawing apparatus comprises a tubular body 6, a first cover 7, and a second cover 8.

The tubular body 6 is integrally formed with a liquid-storage chamber 61 and an air supply chamber 63. The liquid-storage chamber 61 stores liquid such as a liquid pigment including dye, ink, colorant, etc. A writing element 65 is provided to a front end of the tubular body 6 and communicates with the liquid-storage chamber 61, such that the writing element 65 can absorb the liquid from the liquid-storage chamber 61 to allow a user to write or paint with the writing element 65 directly. The air supply chamber 63 surrounds the liquid-storage chamber 61 and acts as an air passageway within the tubular body 6.

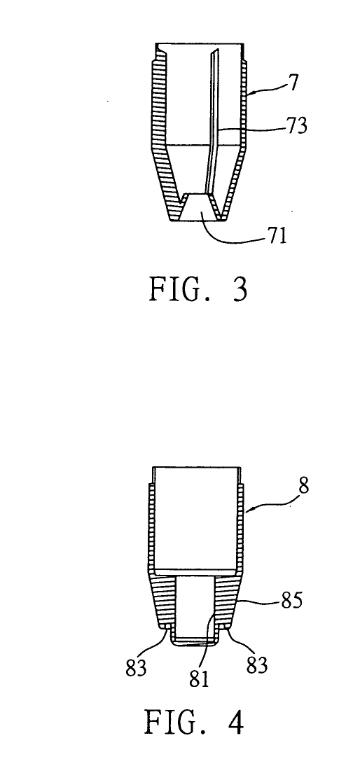

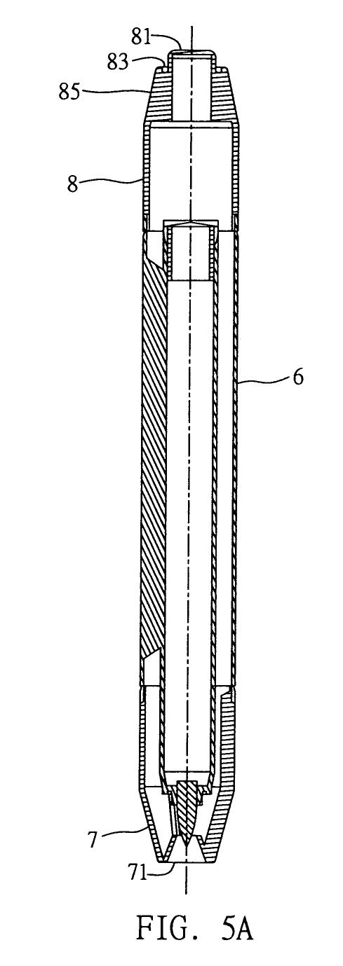

As shown in FIGS. 3 and 4, the first cover 7 and the second cover 8 are each capable of being coupled to either the front end or a rear end of the tubular body 6 in different operational modes. The first cover 7 is formed with an opening 71 and a coupling portion 73. The second cover 8 is formed with a seal portion 81 and at least one air vent 83. The opening 71 is in communication with the ambient and tapers toward the inside of the first cover 7. The coupling portion 73 is disposed inside the first cover 7 and extends toward the taper end of the opening 71, so as to couple the first cover 7 to the tubular body 6 by means of the coupling portion 73, as shown in FIG. 2. The seal portion 81 is provided at one end 85 of the second cover 8, for sealing the writing element 65. The air vent 83 surrounds the seal portion 81; when the second cover 8 is coupled to the tubular body 6, the air vent 83 is in communication with the air supply chamber 63, and the user is allowed to sent airflow through the air vent 83 into the tubular body 6.

It should be understood that, besides surrounding the liquid-storage chamber 61, the air supply chamber 63 can be flexibly arranged in the tubular body 6 as long as acting the air passageway.

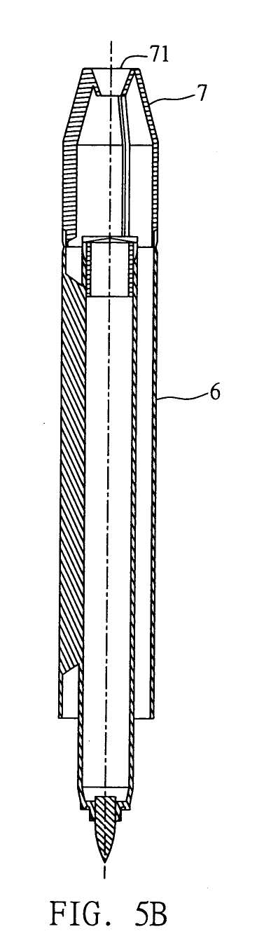

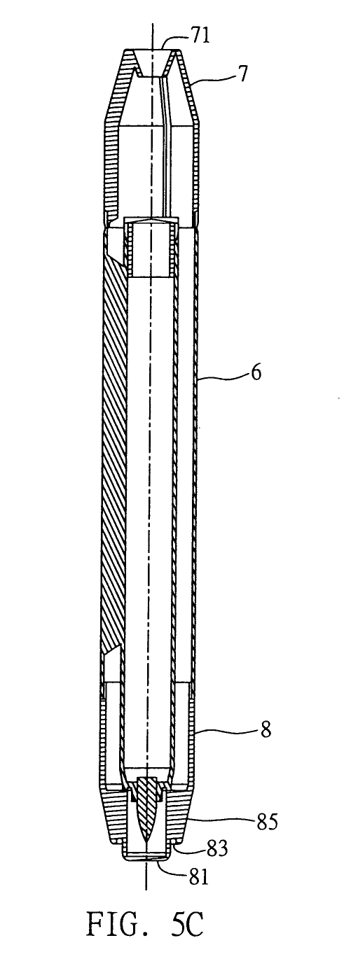

As shown in FIG. 5A, when the first cover 7 is coupled to the front end of the tubular body 6, and the second cover 8 is coupled to the rear end of the tubular body 6, the writing element 65 is in communication with the opening 71 of the first cover 7, and the air vent 83 is in communication with the air supply chamber 63 or air passageway (FIG. 2), such that the user can send the airflow through the air vent 83 to spray particles of the liquid from the opening 71.

As shown in FIG. 5B, when the first cover 7 is removed from the front end of the tubular body 6 while being attached to the rear end of the tubular body 6, the user can write or paint directly using the writing element 65 of the tubular body 6.

As shown in FIG. 5C, when the spray-drawing apparatus is not in use, the second cover 8 can be coupled to the front end of the tubular body 6, such that the writing element 65 can be sealed by the seal portion 81 of the second cover 8.

Further, a lid (not shown) may be detachably coupled to the liquid-storage chamber 61 for use to refill or change the liquid within the liquid-storage chamber 61 and also keep the liquid airtight. The liquid-storage chamber 61 with the lid may be replaced by a cylindrical refill of the liquid.

The writing element 65 can be a felt-tipped pen, porous-tipped pen, highlighter, ink drawing pen, marker, etc., which can output the liquid from the liquid-storage chamber 61.

Second Preferred Embodiment

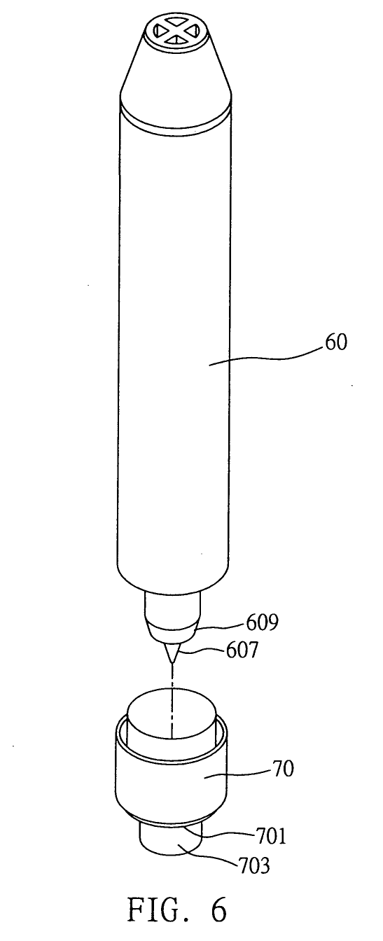

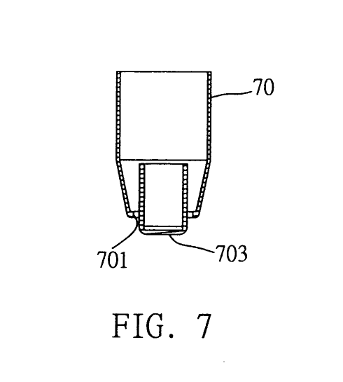

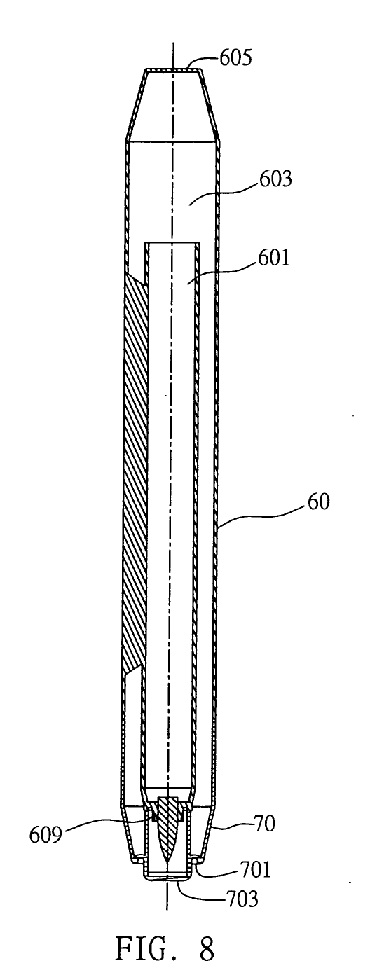

FIGS. 6 through 8 show a spray-drawing apparatus according to a second preferred embodiment of the present invention. As shown in the drawings, this spray-drawing apparatus differs from the apparatus of the first preferred embodiment in comprising a tubular body 60 and a cover 70 only.

As shown in the drawings, the tubular body 60 is integrally formed with a liquid-storage chamber 601 for storing liquid, an air supply chamber 603 surrounding the liquid-storage chamber 601 for acting as an air passageway, and at least one air vent 605. A writing element 607 is provided to a front end of the tubular body 60 and communicates with the liquid-storage chamber 601, such that the writing element 607 can absorb the liquid from the liquid-storage chamber 601 to allow user to write or paint with the writing element 607 directly. The air vent 605 is provided at a rear end of the tubular body 60 and in communication with the air supply chamber 603, for allowing the user to send airflow from the air vent 605 into the tubular body 60.

The cover 70 can be coupled to the tubular body 60 and is formed with an opening 701 and a seal portion 703. The opening 701 is in communication with the ambient. The seal portion 703 is detachably coupled to the opening 701 of the cover 70. When the cover 70 is coupled to the front end of the tubular body 60, the opening 701 is in communication with the writing element 607, and the user can send the airflow through the air vent 605 to spray particles of the liquid from the opening 701. When the spray-drawing apparatus is not in use, the seal portion 703 can be used to seal and keep the writing element 607 airtight.

Besides, the seal portion 703 may also be integrally formed with the cover 70 for use to seal the writing element 607 and prevent leaking of the liquid stored in the liquid-storage chamber 601. Moreover, the opening 701 may be flexibly shaped as long as capable of spraying the particles of liquid in a control manner.

In operation of the spray-drawing apparatus, it only needs to remove the seal portion 703 from the opening 701 for spray painting.

In comparison with the prior-art apparatus, the spray-drawing apparatus according to the invention is provided with the integrally formed tubular body; in operation, the cover(s) can be coupled to or removed from the tubular body to perform different functions, such as writing, drawing and spray-painting, of the spray-drawing apparatus, and this operation is easily achieved even by a child, such that the spray-drawing apparatus according to the invention is more simpler in structure, assembly and operation than the prior-art apparatus, thereby more cost-effective to manufacture.

Moreover, the length of the tubular body is similar to the average length of a pen, which is thus easier to be held and controlled by hand than the prior-art apparatus having a shorter body.

Therefore, the spray-drawing apparatus according to the invention is beneficial of being cost-effective and simple to manufacture and assemble as well as easy and convention to use and provide different functions.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A spray-drawing apparatus, comprising:
a tubular body integrally formed with a liquid-storage chamber for storing liquid, and an air supply chamber surrounding the liquid-storage chamber for acting as an air passageway, wherein a writing element is provided to a front end of the tubular body for communicating with the liquid-storage chamber;
a first cover coupled to one of the front end and a rear end of the tubular body and formed with an opening which allows the writing element to communicate with the ambient via the opening at the time the first cover is coupled to the front end of the tubular body, and a coupling portion for coupling the first cover to the tubular body; and
a second cover coupled to one of the front end and the rear end of the tubular body, and formed with a seal portion and at least one air vent, wherein when the second cover is coupled to the rear end of the tubular body, the air vent is capable of being in communication with the air supply chamber so as to allow a user to send airflow through the air vent into the tubular body to spray particles of the liquid from the opening of the first cover.

2. The spray-drawing apparatus according to claim 1, wherein a lid is detachably coupled to the liquid-storage chamber for use to seal or change the liquid.

3. The spray-drawing apparatus according to claim 1, wherein the first cover is coupled to the front end of the tubular body, to allow the airflow from the user to spray the particles of the liquid from the opening when the second cover is coupled to the rear end of the tubular body.

4. The spray-drawing apparatus according to claim 1, wherein the second cover is coupled to the front end of the tubular body so as to allow the seal portion to seal the writing element in an airtight manner.

5. The spray-drawing apparatus according to claim 1, wherein the liquid stored in the liquid-storage chamber is a liquid pigment.

6. A spray-drawing apparatus, comprising:
a tubular body integrally formed with a liquid-storage chamber for storing liquid, an air supply chamber surrounding the liquid-storage chamber for acting as an air passageway, and at least one air vent formed at a rear end of the tubular body, wherein a writing element is provided to a front end of the tubular body for communicating with the liquid-storage chamber, and a user is allowed to send airflow through the air vent into the tubular body; and
a cover detachably coupled to the tubular body and formed with an opening in communication with the ambient, so as to allow the airflow from the user to spray particles of the liquid through the opening at the time the cover is coupled to the tubular body, wherein a seal portion is detachably coupled to the cover for sealing the writing element.

7. The spray-drawing apparatus according to claim 6, wherein the cover with the seal portion is coupled to the front end of the tubular body so as to keep the writing element airtight by means of the seal portion.

8. The spray-drawing apparatus according to claim 6, wherein the liquid stored in the liquid-storage chamber is a liquid pigment.

9. The spray-drawing apparatus according to claim 1, wherein the writing element absorbs the liquid from the liquid-storage chamber to allow the user to write or paint therewith.

10. The spray-drawing apparatus according to claim 6, wherein the writing element absorbs the liquid from the liquid-storage chamber to allow the user to write or paint therewith.

11. The spray-drawing apparatus according to claim 1, wherein the writing element is selected from the group consisting of a felt-tipped pen, porous-tipped pen, highlighter, ink drawing pen, and marker.
